(19) United States
(12) Patent Application Publication
(10) Pub. No.: US 2015/0154612 A1
(43) Pub. Date: Jun. 4, 2015

(54) SYSTEM AND METHOD FOR DETERMINING THE LEGITIMACY OF A LISTING

(71) Applicant: Google Inc., Mountain View, CA (US)

(72) Inventor: Douglas Richard Grundman, Rosemont, PA (US)

(21) Appl. No.: 13/748,001

(22) Filed: Jan. 23, 2013

(51) Int. Cl. G06Q 30/00

(52) U.S. Cl. CPC G06Q 30/0185

(57) ABSTRACT

A system and method is provided wherein, in one aspect, the likelihood of a listing being spam is determined based on the frequency that a term contained in the listing appears in updates to a set of listings, and further based on the estimated monetary value of the term to an entity that submitted a spam listing. The likelihood that the listing is spam may be used to determine the position of the listing within search results to be displayed to a user.

### BACKGROUND

Existing systems permit users to search listings that are associated with specific geographic locations. For example, a user may search for “pizza” while viewing a map and in response the service may provide search results. The search results may include listings that are proximate to the map and fall within the category of pizza restaurants (or otherwise match the request such as having the term “pizza” in their company name). The service may also return other types of search results, such as advertisements from companies that paid to have their advertisements shown when a user queries one or more terms regardless of the map being viewed.

The results of the search may be ranked based on the likelihood that the result will be of interest to the user that submitted the query. Other factors may be used as well, such as the reliability and safety of the search result, and whether the result is associated with a geographic location of interest to the user.

The business listing search results, or data identifying a business, its contact information, web site address, and other associated content, may be displayed on a map such that a user may easily identify which businesses are located within a particular area.

Some of the listings may be spam, e.g., the user that submitted the listing may not have a legitimate business at the location but is instead using a fake listing to present their actual business phone number to more potential customers. Such users often have a sophisticated understanding of how results are ranked by search engines. Such users may monitor how high their listing is ranked in search results and make major or minor modifications to increase their ranking. For example, such a user may submit many listings for the same business and continuously change the listings so the user can determine, through analysis or trial and error, the most effective way of increasing its ranking in a search engine.

### BRIEF SUMMARY

In one aspect, a method is provided that provides a user with search results where the presence or position of a listing is based on the likelihood the listing is spam. For example, a processor may determine a frequency value based on the frequency that a term is associated with updates to a set of listings that describe businesses and are stored in the memory of a computer. A monetary value of the term contained in a listing's description may also be determined, where the monetary value is a value that is based on the expected monetary return to a user submitting a listing with the term and having the listing appear in search results displayed to other users. A processor may further determine, for the term, a spam value that is associated with the likelihood that the term appears in spam listings. The spam value may be determined based on the frequency value of the term and the monetary value of the term. A processor may further identify a spam value for each listing in the set based on the spam values of at least one term contained in the listing's description. The spam value of the listing is associated with the likelihood that the listing is spam. In response to receiving a search request from a user, the user may be provided with search results, wherein the presence or position of a listing relative to other search results is based on the spam likelihood value of the listing.

In another aspect, a system is provided that includes a processor and a memory containing instructions accessible by the processor. The memory may contain data accessible by the processor where the data includes a plurality of listings. Each listing may include a description of a business, a geographic location and an identification of the submitter, i.e., the user controlling the content of the description. The instructions may include: determining a first value associated with a term based on the number of times that the term appears in a listing description that has been updated within a predefined time period; determining a second value associated with the term based on the estimated monetary return the submitter of a listing may receive if the listing is highly ranked within search results displayed to another user in response to a query, where the listing is included among the search results based on the term's presence in the description and the term's association with the terms contained in the query; determining a third value associated with each listing, the third value being based on the first and second values associated with a term contained in the description of the listing; and in response to receiving a search request associated with a geographic location, providing a user with a ranked list of search results containing at least one of the listings, wherein the rank of the listing is based on the third value associated with the listing.

In still another aspect, a system may include a processor and a memory containing instructions accessible by the processor, where the instructions include transmitting a search request containing search terms over a network to a computer, the search request being associated with a geographic location. The instructions may further include receiving search results from the computer based on the search terms, wherein the search results are associated with the search terms, wherein the received search results include a first listing associated with the geographic location, and wherein the position of the first listing relative to the other search results is based on: (a) the number of times that a term contained in a user-submitted field of the first listing appears in user-submitted updates to a field of other listings, the updates occurring during a time period and (b) the number of times that such term appears in a user-submitted field of other listings. The instructions may also include displaying the search results on an electronic display.

### BRIEF DESCRIPTION OF THE DRAWINGS

FIG. 1 is a functional diagram of a system.

FIG. 2 is a diagram of sample data.

FIG. 3 is a diagram of sample data.

FIG. 4 is a diagram of sample data.

FIG. 5 is a sample screen shot

FIG. 6 is a flowchart.

FIG. 7 is a flowchart.

### DETAILED DESCRIPTION

In one aspect, a system and method is provided that determines the likelihood that a geographically-associated listing is spam by analyzing both the monetary value of search terms associated with listings and the frequency with which search terms appear in updates to the listings. By way of example, if a user changes a listing often, and if the listing incorporates search terms that tend to have relatively high monetary value if the listing's owner is highly ranked in corresponding search results, then the listing may be controlled by an entity that is attempting to obtain a high ranking without regard to whether the entity is a business legitimately associated with the search terms.

System 100 may comprise a device or collection of devices, such as but not limited to a server 110 containing a processor 120, memory 130 and other components typically present in general purpose computers.

Memory 130 stores information accessible by processor 120, including instructions 131 and data 135 that may be executed or otherwise used by the processor 120. The memory 130 may be of any type capable of storing information accessible by the processor, including a computer-readable medium or other medium that stores data that may be read with the aid of an electronic device, such as ROM, RAM, a magnetic or solid-state based hard-drive, a memory card, a DVD or other optical disks, as well as other volatile and non-volatile write-capable and read-only memories. Systems and methods may include different combinations of the foregoing, whereby different portions of the instructions and data are stored in different locations on different types of media.

The instructions 131 may be any set of instructions to be executed directly (such as object code) or indirectly (such as scripts or collections of independent source code modules interpreted on demand) by the processor. For example, the instructions may be stored as computer code on a computer-readable medium. In that regard, the terms “instructions,” “programs” and “applications” may be used interchangeably herein. Functions, methods and routines of the instructions are explained in more detail below.

The data 135 may be retrieved, stored or modified by processor 120 in accordance with the instructions 131. For instance, although the system and method is not limited by any particular data structure, the data may be stored in computer registers, in a relational database as a table having a plurality of different fields and records, XML documents or flat files. The data may also be formatted in any computer-readable format. By further way of example only, image data may be stored as bitmaps comprised of grids of pixels that are stored in accordance with formats that are compressed or uncompressed, lossless (e.g., BMP) or lossy (e.g., JPEG), and bitmap or vector-based (e.g., SVG), as well as computer instructions for drawing graphics. The data may comprise any information sufficient to identify the relevant information, such as numbers, descriptive text, proprietary codes, references to data stored in other areas of the same memory or different memories (including other network locations) or information that is used by a function to calculate the relevant data.

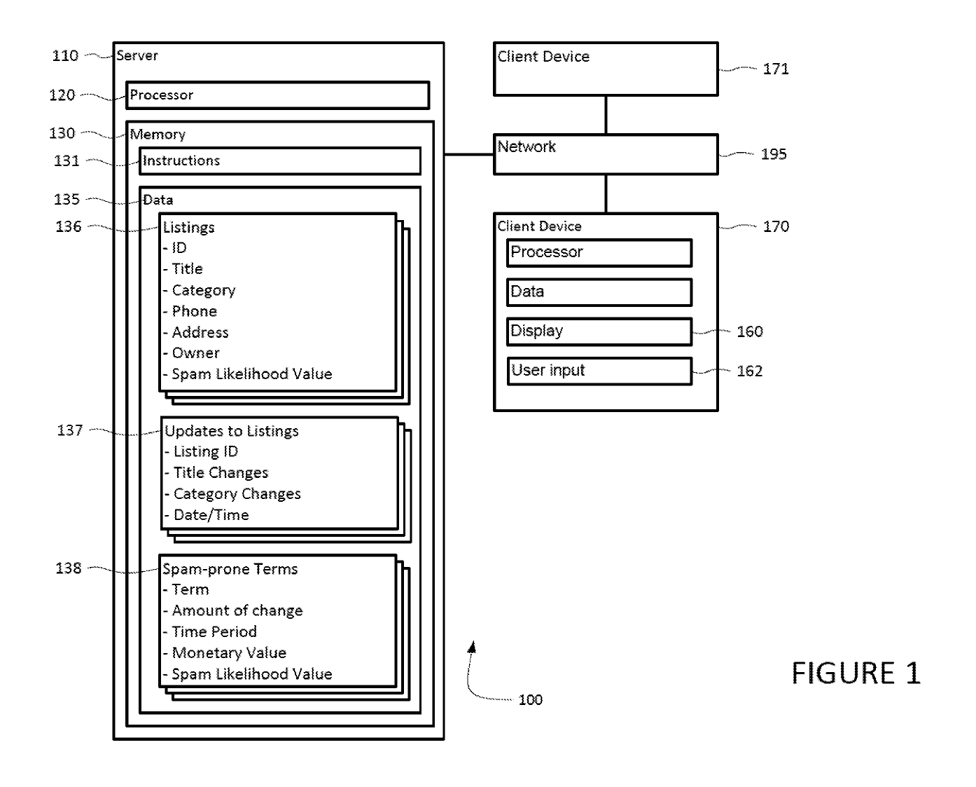

The processor 120 may be any conventional processor, such as processors from Intel Corporation or Advanced Micro Devices. Alternatively, the processor may be a dedicated device such as an ASIC. Although FIG. 1 functionally illustrates the processor, memory, and other elements as being within the same block, those of ordinary skill in the art will understand that the processor and memory may actually comprise multiple processors and memories that may or may not be stored within the same physical housing. For example, rather than being stored in the same computer, processor 120 and memory 130 may be stored in separate servers or have various portions distributed among many servers.

The server 110 may be at one node of a network 195 and capable of directly and indirectly communicating with other nodes of the network such as client devices 170-171. Network 195 and the server's communication with other devices, including computers, connected to the network may comprise and use various configurations and protocols including cellular networks (e.g., 4G LTE), other wireless networks (e.g., WiFi), the Internet, intranets, virtual private networks, local Ethernet networks, private networks using communication protocols proprietary to one or more companies, instant messaging, HTTP and SMTP, and various combinations of the foregoing. Although only a few devices are depicted in FIG. 1, a typical system can include a large number of connected devices.

While not limited to any particular type of product, devices 171 may be a cell phone, tablet or portable personal computer intended for use by a person and includes components normally used in connection with such devices such as an electronic display 160 (e.g., a small LCD touch-screen, a monitor having a screen, a projector, a television, or any other electrical device that is operable to display information), user input 162 (e.g., a mouse, keyboard, touch screen or microphone), camera, speakers, a network interface device and all of the components used for connecting these elements to one another. Indeed, devices in accordance with the systems and methods described herein may comprise any device capable of processing instructions and transmitting data to and from humans including general purpose computers. Server 110 may thus display information on display 160 of client device 170 via network 195.

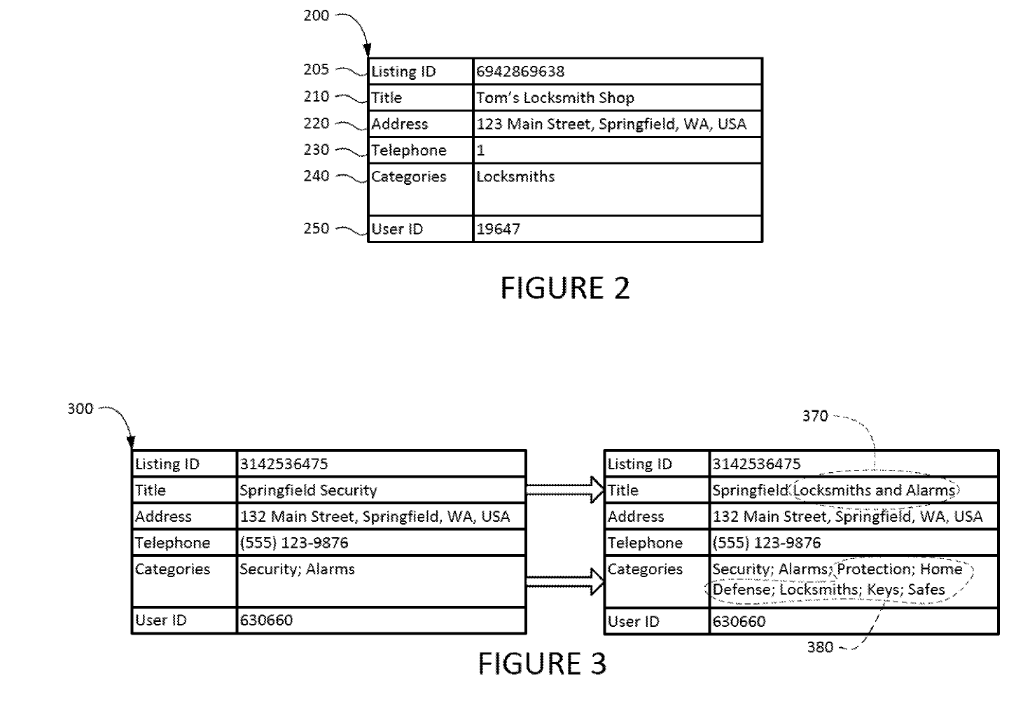

The system and method may access listing information identifying local businesses or other objects or features associated with particular geographic locations. For example, data 135 accessible by processor 120 of server 110 may include Listings Database 136. Listings 136 may store information such as that shown in listing 200 of FIG. 2, where each listing is associated with a unique identifier 205, a name or title 210 (e.g., “Tom's Locksmith Shop”), one or more categories 240 (e.g., “locksmith” or “hotel”), contact information for customers (e.g., telephone number 230), other information (e.g., a website address) and a geographic location 220.

The geographic location 220 may be stored in a variety of formats with varying levels of precision. By way of example, the geographic location may be stored as a street address. However, the location data may also specify a large region (e.g., a city or state) or a very specific point (e.g., a precise latitude/longitude position). The server may include the components necessary to convert geographic location data from one format to another, such as converting a street address into a latitude/longitude position by the use of a geocoder or the like.

The listings in the Listing Database 136 may be obtained in a variety of ways. For example, some listings may be obtained by automatically gathering business information (such as from websites or telephone directories).

Other listings may be obtained based on user submissions. By way of example, a user at client device 170 may log into a web page served by server 110, create a new listing and manually enter the relevant information into the web page. The new listing would then be stored in Listing Database 136. The listing may also associate a user 250 with the listing, e.g., the user that submitted, owns or controls the listing. The user may be a single person, a collection of people, a legal entity such as a corporation, or any other entity capable of providing a listing to the server. For instance, the user 250 may be a computer—particularly if the computer emulates the behavior of a user for the purpose of preventing server 110 from detecting that the submitter is not human.

In many cases, there will be a single listing 210 in the map database 270 for each different business. However, the same business may be associated with many different listings, and a single listing may be associated with many different businesses.

Listings may include other geographically-located objects in addition to or instead of businesses. For example, they may also identify individual's homes, landmarks, roads, bodies of land or water, etc. Therefore, while many of the examples below refer to business listings, most aspects of the system and method are not limited to any particular type of listing.

The system and method may track updates for future reference. In that regard, the server 110 may store a database of updates 137 in data 135, where each update identifies the relevant listing, the nature of the change, and the date and time of the change.

Some users may submit listings that have the appearance of, but actually are not, associated with local businesses that legitimately provide the services described in the listing. For instance, a user (“spammer”) may have entered a spam listing, e.g., a listing that is not associated with a local business (e.g., it may list a fake address in its listing), a listing for a business that is incapable of providing or unwilling to provide the goods associated with the listing (e.g., a product or service) in accordance with the reasonable expectations of customer, a listing of a business that historically uses fraud or other deceitful tactics to charge fees much greater than the market value of the relevant goods, etc. By way of continuing illustration and as shown in FIG. 3, a spammer may have entered listing 300 with the title 310 of “Springfield Security” and the address 320 of “132 Main Street, Springfield, Wash., USA”—in spite of the fact that the user does not have a business at that location. Yet further, such a user may determine through analysis or trial and error that a few minor changes to the listing will increase its ranking, such as the changes 370 to the title and the addition of new categories 380. Spammers often make changes more frequently to their listings than legitimate users. Spammers may also enter many listings that are only slight variants of one another, check how often each listing is selected by a user, and use this information to change other listings to obtain a higher ranking.

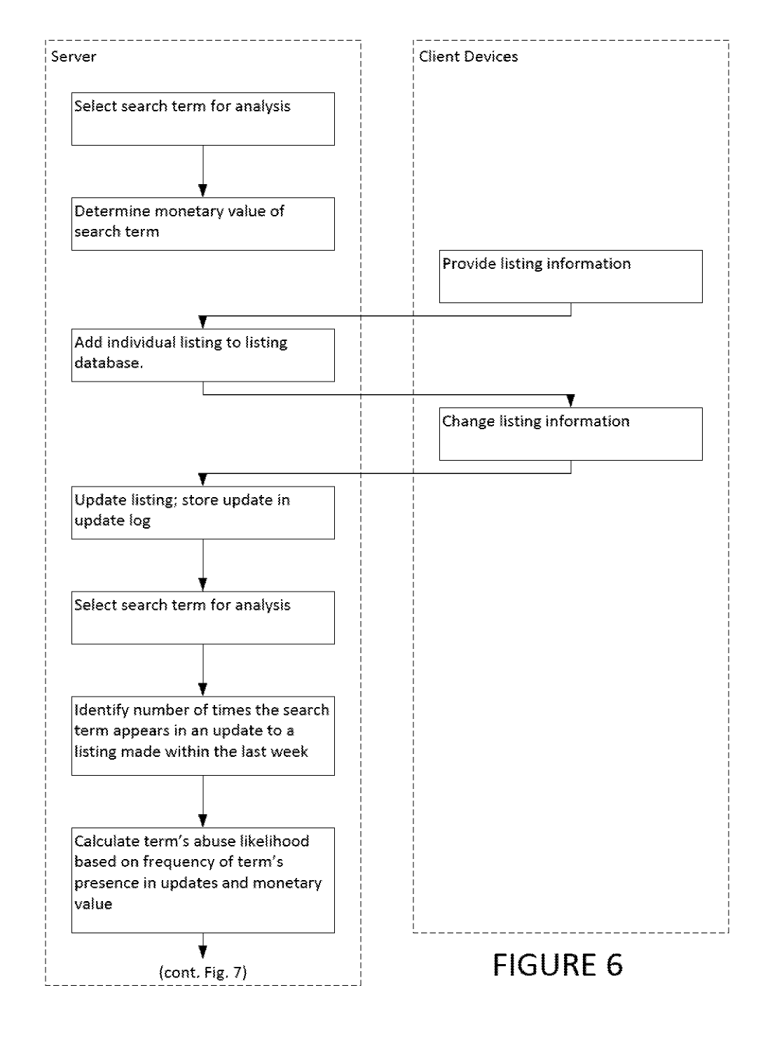

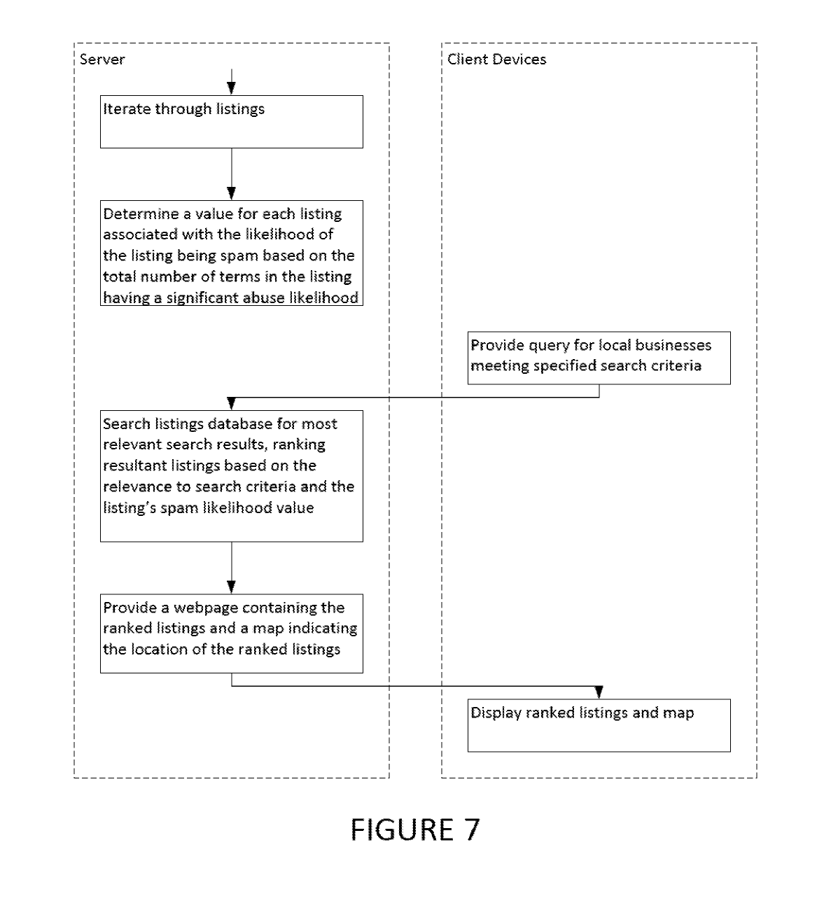

In addition to the operations illustrated in FIGS. 6-7, operations in accordance with the system and method will now be described. Various operations can be handled in a different order or simultaneously, and each operation may be composed of other operations.

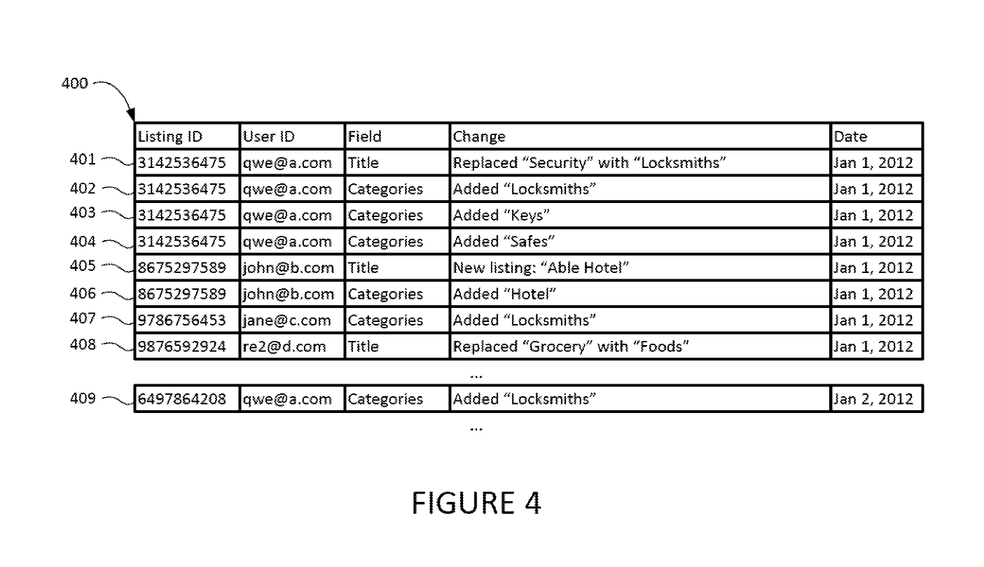

Users such as a user at computer 170 may update the listings they control. For example, as noted above, a user may add categories and change the title. Server 110 may keep a log of each change, storing data such as that shown in table 400 of FIG. 4. According to table 400, four changes 401-04 were made to listing no. 3142536475 on Jan. 1, 2012, namely the user changed the title of the listing from “Security” to “Locksmiths”, and added “Locksmiths”, “Keys” and “Safes” as categories. The log will typically include many other changes as well, only a small portion of potentially tracked changes being shown in FIG. 4. According to updates 407 and 408, at least two other listings added “locksmiths” as categories shortly thereafter.

The system and method may determine the extent of the change in the updates with respect to particular terms. By way of example, server 110 may calculate how frequently a term appears in a listing update, i.e., the number of times the term appears in an update over a certain period of time. Based on the data stored in table 400, the system and method may determine that the term “locksmith” appeared in an update three times in one day, and four times over two days. Thus, the system and method may assign a value of three or four to the term's flux, i.e., a value indicative of how often the term was used over a period of time that may be used for comparison with how often other terms were used over a similar period of time.

The system and method may determine the flux value based on a variety of source data. For example, server 110 may select a set of search terms and, for each selected search term, determine the total number of updates that include that search term. The flux value may then be set to that total. A subset of all updates may also be selected for analysis, e.g., server 110 may examine randomly selected updates or only those updates associated with users holding many accounts.

The search terms to be analyzed may be selected on a variety of bases, e.g., it may exclude noise words (e.g., “the”) or words that are highly unlikely to be particularly prone to use in spam.

In one aspect, the system and method may distinguish between updates that add a term, remove a term or change the order of a term. For example, an update that adds the term “locksmith” may add two points to the flux value, an update that changes the order of “locksmith” may add one point (e.g., from “Springfield Alarms and Locksmiths” to “Springfield Locksmith and Alarms”), and an update that removes the term “locksmith” may subtract one point from the flux value.

A higher value may also be placed on updates in certain fields. For example, the server may increase the flux value by two points if the change occurs in a title and increase the flux value by one point if the change occurs in a category.

Yet further, the flux value is not limited to totaling the number of updates containing the term. For example, the system and method may determine the number of times the term appears in a listing that has been updated regardless of whether the term itself was updated. For example, as shown in FIG. 3, the term “Locksmith” was added to title 310 of listing 300 but the category of “Alarms” remains unchanged. The flux value for the term “Alarms” may be increased nonetheless because the term “Alarms” was present in a listing that was updated.

A variety of time periods may be used to determine a term's flux value. By way of example only, the flux value may be determined based on the number of changes in a single day, a single week or two weeks. It may also be calculated at time intervals that differ from the time period used to calculate the flux value. For instance, the server 110 may calculate the flux value of a term every day, but the flux value itself may be based on the number of times the term appeared in an update made to a listing during the prior seven days. In one aspect, the time period used to calculate the flux value takes into account periodic and expected variations in updates, e.g., more updates might be expected on the weekend than on a weekday. By setting the time period at a week, the quantity differences between weekend and weekday updates may average out.

The system and method may also associate a monetary value with the terms in the listing, where the monetary value is related to the estimated monetary return a spammer may receive if the spammer's listing is highly ranked in search results due to the presence of the term in listing.

By way of example, the monetary value may represent the range or average amount of money that the spammer may receive if the spammer's listing was selected by a customer and the customer subsequently decided to purchase goods from the spammer. Thus, the monetary value of the term “locksmith” may be set at $100 if the spammer is typically able to convince 1 out of 10 searching users to give the spammer $1,000 (e.g., by promising to fix a lock for $40 and, after destroying the door, demanding $1,000).

The monetary value may also represent the average amount that a legitimate user may receive if the legitimate user's listing was selected by a customer and the customer subsequently decided to purchase goods from the legitimate user. Using the foregoing example, the monetary value of the term “locksmith” may be set to $50 if that is the average price that a locksmith charges for fixing a lock.

Yet further, the monetary value may be set equal to the average amount of money that server 101 receives if the search term is used to display an advertisement to a user and the user selects the advertisement, e.g., the cost-per-click.

The monetary value may be determined in various ways and depend on various factors. For example, the monetary value may be determined by accessing a database of terms and values compiled by experts knowledgeable in Internet fraud. Such experts may become aware that certain types of businesses are prone to fraud. Based on such knowledge, the words that consumers use to search for such fraud-prone industries may be ascribed a relatively high monetary value based on the expert's approximation of how much money fraudulent companies might collect per incident in the relevant business.

The monetary value of terms in listings may also be automatically calculated by a processor based on information existing outside of the listing database. By way of example, a server may compile information available from a business' website, identify pages that are likely to represent the price of the business' products and services, identify the terms on the site that describe the product and service, and use the price as the monetary value of the descriptive terms. The price may also be averaged or otherwise extracted from an analysis of many sites.

Yet further, the monetary value may also be approximated based on indicia that are likely correlated with the term's monetary value but are not, in themselves, monetary values. For example, the monetary value may be assigned a relative value that is based on the popularity of the term within the Listing Database 136, i.e., the number of times the word appears in the listings and not just updates to the listings.

The monetary value may further be selected based on the nature of the relevant business. For instance, a relatively high monetary value may be assigned to businesses that are consumer-oriented and provide the products or services at the consumer's home rather than via a storefront (e.g., taxis, hotels, garage door salespeople, towing services, plumbers, etc.).

The monetary value may also be based on some or all of the foregoing factors, e.g., a computer may suggest a monetary value that is reviewed by a person knowledgeable of Internet fraud.

The monetary value may be calculated in other ways as well, and does not need to be expressed as a specific dollar value or other currency value. For instance, the monetary value of a term may be normalized relative to the monetary value of other terms, and assigned a floating point number between 0 and 1. The monetary value may also be assigned a discrete value, such as 3 for the most valuable listing terms, 0 for the least valuable listing terms, and 1 and 2 for terms of intermediate monetary value.

The term's flux value and monetary value may be used together to determine a value that relates to the likelihood that the term will be used in spam listings. For instance, a processor may multiply the term's monetary value by the flux value and use the result as the term's spam likelihood value. In addition or alternatively, the processor may compare the result to a threshold and, if the result exceeds the threshold, flag it as prone to spam.

The term's spam likelihood value may be used to determine the likelihood that a listing is spam. For example, server 110 may iterate through listings 136, determine how often a term having a high spam likelihood value appears in the listing, and total all of the spam likelihood values associated with the various terms. By way of example, if server 110 determines that a particular term has a relatively low spam likelihood value, the server may not consider such a term when calculating the spam likelihood value of a listing. The resulting value may be used to estimate the likelihood that the listing is spam, and any listing spam likelihood value that exceeds a threshold may be considered. For instance, if the server determined that “locksmith” and “alarm” are spam-prone terms, the server may assign a spam likelihood value of four to updated listing 300 because the two terms appear a total of four times in the listing. If this value exceeds the threshold (e.g., three), the updated listing 300 may be flagged as spam.

The server may use a variety of other methods to determine the spam likelihood value of a listing, such as increasing the listing's spam likelihood value when a spam-prone term is in a title more than when the term appears in a category. The system and method may also choose to skip certain fields of the listing when calculating the listing's spam likelihood value. Yet further, the system and method may ignore terms of a listing if the term has not been flagged as spam-prone.

The aforementioned thresholds may be determined in a variety of ways. In one aspect, the thresholds may be set to an arbitrary value, which may or may not be changed by a human. The thresholds may also be dynamically determined, e.g., they may be set to always identify a specific percentage of terms or listings as highly correlated with spam. Yet further, the thresholds may be determined based on a combination of factors. By way of example, trained professionals may review large numbers of listings and identify the listings that are suspicious enough to be likely spam. The thresholds may then be dynamically tuned until the percentage of listings flagged by server 110 as spam is comparable to the percentage of suspicious listings identified by the trained professionals.

The thresholds may also be adjusted based on precision and recall. For example, a relatively high threshold may make the system and method more precise by catching less false positives, i.e., a very high percentage of the listings flagged as spam will in fact be spam listings. However, a higher threshold may have an adverse effect on recall, i.e., less spam listings will be identified. The thresholds may thus be tuned to affect the desired level of precision and recall.

Upon identifying a listing as likely to be spam, the system and method may take a number of actions. For example, if the spam likelihood value indicates that the listing is highly likely to be spam, the server 110 may prevent the listing from being displayed in any search results. The server might also flag the listing for manual review and investigation, and take no further action with respect to the listing until a human investigates the listing and determines that the listing should be excluded from or included in search results.

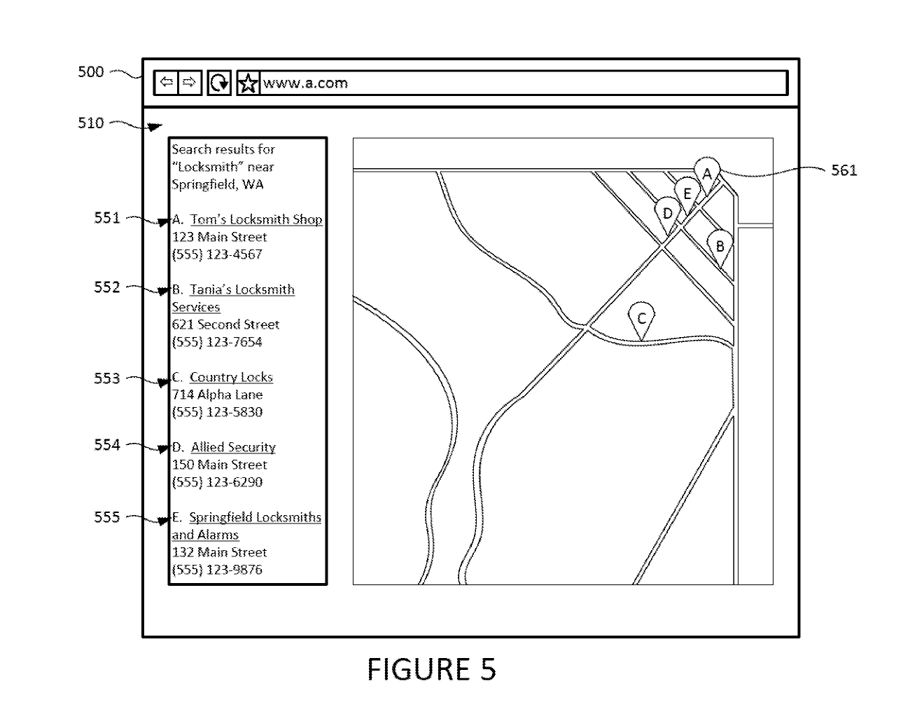

Alternatively and as shown in FIG. 5, the system and method may still include the listing in search results, but with a lower ranking. Webpage 510 of browser 500 illustrates the results of a user searching for “Locksmiths in Springfield, Wash.”. Based on various criteria, such as how well the listing's description matches the search request and the popularity of a website associated with a listing, server 110 will return a list of search results. The geographic locations of the listings, such as icon 561 corresponding with the first listing, may also be displayed on a map 560. By clicking an icon or search result, the browser may load and display more information about the selected listing. But for the spam likelihood value, the listing for “Springfield Locksmiths and Alarms” may have been ranked highly, e.g., shown in one of the most prominent positions on the web page such as at position 551, the first search result.

The high ranking may have occurred at least in part based on the spammer's sophisticated and continuous manipulation of its title and categories for the sole purpose of getting a high ranking. However, because the listing was determined to have a meaningful spam likelihood value (but not so high as to preclude it from being blocked completely), the listing is instead shown last at position 555. The legitimate listing of “Tom's Locksmith Shop” is shown first, in position 551, and there are four other search results between it and the spam listing. In that regard, the listing's spam likelihood value may be one factor among many that is used to determine the listing's ranking value. Indeed, the spam listing may be ranked so low that it does not appear among the first set of search results sent to the user but, rather, is sent with a subsequent set of search results when the user indicates that he or she would like to see another page of listings. The listing may also be sent among search results that are not listings, e.g., the search results may also include links to a website, images of products, etc.

The amount the spam listing's rank is lowered may be proportional to the likelihood that the listing is spam. For instance, the score used to rank a search result may be decreased less for a listing with a low spam likelihood ranking than a listing with a high spam likelihood value.

The system and method may also identify spammers in addition to spam listings. In that regard, if a user is determined to be operating a spam listing, or a given quantity or percentage of the user's listings are determined to be spam, then the user's other listings may also be treated as if they are spam listings. For example, the other listings may be excluded from future search results. Yet further, the spam likelihood value of one listing may depend in whole or in part on the spam likelihood value of the user's other listings. The spammer's other listings may be assigned a spam likelihood value that is based on the spam likelihood value of the listings that were determined to be spam.

As these and other variations and combinations of the features discussed above can be utilized without departing from the systems and methods as defined by the claims, the foregoing description of exemplary embodiments should be taken by way of illustration rather than by way of limitation of the invention as defined by the claims. It will also be understood that the provision of examples of the invention (as well as clauses phrased as “such as,” “e.g.”, “including” and the like) should not be interpreted as limiting the invention to the specific examples; rather, the examples are intended to illustrate only some of many possible aspects. The sample values, types and configurations of data described and shown in the figures are for the purposes of illustration only. Unless expressly stated to the contrary, every feature in a given embodiment, alternative or example may be used in any other embodiment, alternative or example herein.

1. A method comprising:
determining, with a processor, a frequency value based on the frequency that a term is associated with updates to a set of listings stored in the memory of a computer, each listing within the set comprising a description of a business;
determining an estimate of a monetary value of a term contained in at least one description of the set of listings, the monetary value being based on the expected monetary return to a user submitting a listing with the term and having the listing appear in search results displayed to other users;
determining, with a processor, a spam value for the term based on the frequency value of the term and the monetary value of the term, the spam value being associated with the likelihood that the term appears in spam listings;
identifying, with a processor, a spam value for each listing in the set of listings based on the spam values of at least one term contained in the description of the listing, the spam value of the listing being associated with the likelihood that the listing is spam; and
in response to receiving a search request from a user, providing the user with search results, wherein the presence or position of a listing relative to other search results is based on the spam likelihood value of the listing.

2. The method of claim 1 wherein each listing in the set of listings is associated with a geographic location, the search results are associated with the geographic location, and the monetary value is based on the likelihood of a user receiving a monetary payment from a user in the geographic location.

3. The method of claim 1 wherein the frequency value for a term is determined, with a processor, by totaling the number of times that a term appears in user-submitted updates made to the set of listings over a period of time.

4. The method of claim 3 wherein the frequency value is determined based on the number of times that the term was added to a listing.

5. The method of claim 1 wherein the frequency value for a term is based on totaling the number of times that a term appears in any listings in the set that were updated during a period of time.

6. The method of claim 1 wherein the description of the listing comprises a title field and a category field, and the frequency value of a term is based on the presence of the term in the fields.

7. The method of claim 6 wherein the frequency value of the term is more dependent on the presence of the term in the title than the presence of the term in a category.

8. The method of claim 1 wherein the monetary value of a term is determined with a processor by identifying prices published on websites for goods that are associated with the term and calculating a value based on the identified prices.

9. The method of claim 1 wherein the monetary value of a term is determined with a processor by selecting a value that is proportional to the number of listings having a description containing the term.

10. The method of claim 1 wherein the monetary value of a term is selected based on data identifying terms that have been previously submitted by users in connection with spam listings.

11. The method of claim 1 further comprising determining the spam likelihood value of a first listing, identifying the user that submitted the first listing, identifying other listings submitted by the user, and wherein the position of the other listings within search results provided to another user is based on the spam likelihood value of the first listing.

12. A system comprising:
a processor;
a memory containing instructions accessible by the processor;
a memory containing data accessible by the processor, said data comprising a plurality of listings, each listing comprising a description of a business, a geographic location and an identification of a submitter, where the submitter comprises the user controlling the content of the description;
said instructions comprising:
determining a first value associated with a term based on the number of times that the term appears in a listing description that has been updated within a predefined time period;
determining a second value associated with the term based on the estimated monetary return the submitter of a listing may receive if the listing is highly ranked within search results displayed to another user in response to a query, where the listing is included among the search results based on the term's presence in the description and the term's association with the terms contained in the query;
determining a third value associated with each listing, the third value being based on the first and second values associated with a term contained in the description of the listing; and
in response to receiving a search request associated with a geographic location, providing a user with a ranked list of search results containing at least one of the listings, wherein the rank of the listing is based on the third value associated with the listing.

13. The system of claim 12 wherein the first and second value are collectively associated with the likelihood that the term is used in spam listings.

14. The system of claim 12 wherein the third value is associated with the likelihood that the listing is a spam listing.

15. The system of claim 12 wherein the first value is based on the number of times that the term was added to a listing.

16. A system comprising:
a processor, and
a memory containing instructions accessible by the processor,
said instructions comprising:
transmitting a search request containing search terms over a network to a computer, the search request being associated with a geographic location;
receiving search results from the computer based on the search terms, wherein the search results are associated with the search terms, the received search results including a first listing associated with the geographic location, and the position of the first listing relative to the other search results is based on: (a) the number of times that a term contained in a user-submitted field of the first listing appears in user-submitted updates to a field of other listings and (b) the number of times that such term appears in a user-submitted field of other listings; and
displaying the search results on an electronic display.

17. The system of claim 16 further comprising determining the position of such listing relative to the other search results based on the number of times that the term appears in a user-submitted update to a field of other listings during a time period.

18. The system of claim 16 further comprising determining the position of such listing relative to the other search results based on the number of times that the term appears in a user-submitted update relative to a field of other listings during a time period.

19. The system of claim 16 further comprising receiving a map of the geographic location and simultaneously displaying the search results and the map.

20. The system of claim 16 wherein the search results are received in successive sets, each set being received and displayed in response to a user request, and the first listing is excluded from the first displayed set of search results.
